(19) United States
(12) Patent Application Publication
(10) Pub. No.: US 2015/0099053 A1
(43) Pub. Date: Apr. 9, 2015

(54) OIL-IN-WATER-TYPE EMULSION GEL FOOD

(71) Applicant: FUJI OIL COMPANY LIMITED, Osaka (JP)

(72) Inventors: Hirofumi Kugitani, Ibaraki (JP); Takayasu Motoyama, Ibaraki (JP); Chiaki Miyazaki, Ibaraki (JP); Ryuji Yoshida, Ibaraki (JP); Shin Nakatani, Ibaraki (JP); Masahiko Samoto, Ibaraki (JP)

(21) Appl. No.: 14/403,424

(22) PCT Filed: Apr. 30, 2013
(86) PCT No.: PCT/JP2013/062614

§ 371 Date: Nov. 24, 2014

(30) Foreign Application Priority Data
Jun. 21, 2012 (JP) 2012-139394

(51) Int. Cl. A23D 7/005

(52) U.S. Cl. CPC A23D 7/0053
USPC 426/602

(57) ABSTRACT

The object of the present invention is to produce a masticable food, composed of an oil-in-water-type emulsion gel which has a shape-retaining property and an oil-holding property before mastication and from which oil and fat oozes during mastication to make swallowing smooth, by using any oil and fat. An oil-in-water-type emulsion gel food containing oil droplets having a particle diameter of 50-800 μm is used. Preferably, the oil and fat is vegetable oil or fish oil, the food is a heat-sterilized food, and the gel is a soybean protein gel crosslinked by a protein corsslinking enzyme.

### FIELD OF THE INVENTION

The present invention relates to a food composed of an oil-in-water-type emulsion gel which has a shape-retaining property before mastication and from which oil and fat oozes out during mastication, and to a method of preparing the food.

### BACKGROUND OF THE INVENTION

Semi-liquid foods, such as raw cream, mayonnaise, etc., or solid foods, such as chocolate, potato chips, almonds, the fat of pigs or tuna fishes, etc., have an oil-holding property before mastication, and also have a unique texture that allows oil and fat to ooze therefrom during mastication. Among these foods, the solid foods having a shape-retaining property before mastication, particularly the fat of almonds or tuna, allow oil and fat to ooze therefrom upon mastication, thus having a very desirable texture. Meanwhile, since these solid foods originate from natural materials, it is difficult to arbitrarily change the composition of oil and fat thereof.

Meanwhile, there are many types of fatty acids that constitute oil and fat. Among them, medium-chain fatty acids, such as caproic acid, caprylic acid, capric acid, etc., or polyunsaturated fatty acids, such as linoleic acid, α-linolenic acid, γ-linolenic acid, arachidonic acid, eicosapentaenoic acid (EPA), docosahexaenoic acid (DHA), etc., have recently attracted attention because of the importance of fat intake for health. In addition, these oils and fats have high nutritive values and can give variation to the taste or texture of foods, and thus a technology that uses any oil and fat is very important.

Patent document 1 (WO2005/027648) discloses a technology that makes oil droplets in liquid dressing or cream larger by using water-soluble soybean polysaccharides under special preparation conditions, thereby increasing the taste or palatability of food. However, any foods disclosed therein have no shape-retaining property, and there is no food having a mastication property sought by the present invention.

The oozing of oil and fat from food before mastication is a phenomenon that should be avoided. For example, Patent document 2 (Japanese Unexamined Patent Application Publication No. 2002-003883) discloses a technology that suppresses the oozing of oil from a fried food by using a high-melting-point oil and fat in combination with an emulsifier. For many foods having a shape-retaining property and a mastication property, only the avoidance of the oozing of oil and fat from foods having a high oil content has been considered, while improvement in food texture using large oil droplets has not been considered.

The texture of abundant oil and fat during mastication is desirable, and is also expressed as an oily feeling. Several means for increasing an oily feeling have been disclosed. Patent document 3 (Japanese Unexamined Patent Application Publication No. Hei 10-191925) discloses a method of preparing fried rice whose surface is treated with oil and fat and an emulsifier and whose oily feeling is increased. However, in this method, boiled rice is covered with oil, and oil does not ooze out from grains of the boiled rice during mastication. In addition, Patent document 4 (Japanese Unexamined Patent Application Publication No. 2005-168319) discloses a technology in which an emulsion including oil and fat and a starch crosslinked with octenyl succinic acid is added to livestock meat, or fish is immersed in the emulsion, thereby increasing an oily feeling. However, this technology is a technology in which a highly emulsifiable additive is also used and thus fine oil droplets are utilized.

### PRIOR ART DOCUMENTS

### Patent Documents

Patent document 1: International Patent Publication No. WO2005/027648
Patent document 2: Japanese Unexamined Patent Application Publication No. 2002-003883
Patent document 3: Japanese Unexamined Patent Application Publication No. Hei 10-191925
Patent document 4: Japanese Unexamined Patent Application Publication No. 2005-168319.

### SUMMARY OF THE INVENTION

### Disclosure

### Technical Problem

An object of the present invention is to obtain a masticable food, composed of an oil-in-water-type emulsion gel food which has a shape-retaining property before mastication and from which oil and fat oozes during mastication to make swallowing smooth, by using any oil and fat.

### Technical Solution

The present inventors have conducted extensive studies to solve the above-described problems, and, as a result, have found that, when coarse oil droplets are dispersed in a crosslinked gel of soybean protein, it is possible to obtain special physical properties that allow oil and fat to ooze out during mastication while suppressing the oozing of oil and fat before mastication, unlike those of conventional knowledge. In addition, the present inventors have repeatedly examined this knowledge, and, as a result, have found the effects of the properties of the gel and the sizes and amounts of the oil droplets on the above-described texture, thereby leading to the completion of the present invention.

Specifically, the present invention relates to:
(1) an oil-in-water-type emulsion gel food that is obtained by gelling an oil-in-water-type emulsion slurry containing 10-60 wt % of oil droplets having a particle diameter of 50-800 μm;
(2) the oil-in-water-type emulsion gel food set forth in (1), in which the oil droplets having the diameter of 50-800 μm have a plane occupancy ratio of 10-60%, and a gel formed by a non-myosin gelling material is present as a continuous phase;
(3) an oil-in-water-type emulsion gel food that is obtained by gelling an oil-in-water-type emulsion slurry containing 30-50 wt % of oil droplets having a particle diameter of 50-800 μm;
(4) the oil-in-water-type emulsion gel food set forth in (3), in which the oil droplets having the diameter of 50-800 μm have a plane occupancy ratio of 10-40%, and a gel formed by a non-myosin gelling material is present as a continuous phase;
(5) the gel food set forth in any one of (1) to (4), in which the gel food is a heat-sterilized food;
(6) the gel food set forth in any one of (1) to (4), in which the gel food is a frozen food;
(7) the gel food set forth in any one of (1) to (4), in which the gel is a soybean protein gel;
(8) the gel food set forth in (2), in which the gel is a gel crosslinked by a protein crosslinking enzyme.
(9) the gel food set forth in any one of (1) to (4), in which:
   A) the gel food has a breaking stress of 3,000-60,000 N/m², as measured for a 20 mm thick sample using a spherical plunger ((p 5 mm) at 1 mm/second and at any one higher temperature of 20° C. and the melting point of oil and fat contained in the gel;
   B) the percentage of dry weight of a squeezed liquid relative to the gel (the percentage of squeezed liquid) is 10-60 wt %;
   C) the gel formed by the non-myosin gelling material is present as a continuous phase; and
   D) the oil and fat is present as an oil-in-water-type emulsion;
(10) the gel food set forth in (9), in which the oil droplets having the diameter of 50-800 μm have a plane occupancy ratio of 10-60%;
(11) the gel food set forth in (9), in which the gel food is a frozen food;
(12) the gel food set forth in (9), in which the gel is a soybean protein gel;
(13) the gel food set forth in (9), in which the gel is a gel crosslinked by a protein crosslinking enzyme;
(14) a method for preparing a gel food set forth in (8) or (13), in which 25-150 parts by weight of oil and fat is added to 100 parts by weight of an aqueous solution having a soybean protein concentration of 5-15 wt % and having a viscosity of 5,500 mPa·s or less, as measured with a type B viscometer at 55° C. and at a rotator speed of 30 rpm, while the aqueous solution is being stiffed, and is also treated with a protein crosslinking enzyme; and
(15) the method set forth in (14), in which soybean protein in a raw soybean protein material does not have a thermal history of 80° C. or higher in a water system.

### Advantageous Effects

The taste of food is attributable to a flavor (a so-called chemical taste) and a texture (a so-called physical taste). For foods having no shape-retaining property, such juice, soup, etc., a chemical taste is important. In contrast, for foods having a shape-retaining property, such as pudding, pasta, boiled rice, etc., a texture that is a physical taste is more important. In oil and fat, or a food containing oil and fat, a difference in the melting point of oil and fat, etc., leads to a difference in a physical feeling (e.g., an oily feeling). Meanwhile, oil and fat, or a food containing oil and fat may have a special nutritive property in addition to a texture or a flavor, but it may not be necessarily selected from all the three viewpoints: nutrition, flavor, and texture.

According to the present invention, it is possible to obtain a masticable food, composed of an oil-in-water-type emulsion gel food which has a shape-retaining property before mastication and from which oil and fat oozes out during mastication to make swallowing smooth, by using any oil and fat. In addition, it is possible to distribute this food as a heat-sterilized food.

### DETAILED DESCRIPTION OF THE INVENTION

### Mode for Invention

(Masticable Food)

In the present invention, the “masticable food” refers to a solid food that differs from liquid foods, such as beverages, etc, or semi-liquid foods, such as raw cream, mayonnaise, etc., is necessarily masticated for intake, and also has a shape-retaining property before mastication.

(Gelling Material)

For a gelling material, it is sufficient if a material has the capability to be gelled and maintain oil droplets. A gelling material may be selected by taking into account supply stability, economic efficiency, nutritive properties, physiological functionality, and/or qualities such as texture, flavor, color, and/or the like. For example, it is preferable to use a material, such as a polysaccharide or protein. Specifically, the gelling material may be one or more selected from among soybean protein, gelatin, egg albumin, whey protein, mannan, pectin, alginic acid, curdlan, agar, gellan gum, etc., and materials containing any of these. Gelling materials containing protein as a functional component exhibit low dripping, which will be described below, when they have been frozen or thawed. Accordingly, the gelling materials containing protein as a functional component is more preferable than gelling materials containing a polysaccharide as a functional component for the gel food of the present invention. It is preferable to use a gelling material containing gelatin or soybean protein material, etc. because it is smoothly swallowed, and it is more preferable to use a soybean protein material because it is smoothly swallowed even when it has been frozen or thawed. A ground fish cake, etc., which contain myosin protein as a main component, exhibit high viscosity when a gel is prepared. For example, it provides oil droplets having a size smaller than 30 μm even in low-speed stirring as disclosed in Japanese Unexamined Patent Application Publication 2011-177090 (FIG. 3b), and thus it is difficult to obtain a texture attributable to the oozing of oil, which is the feature of the present invention. A gelling material containing protein as a main component may be used in combination with a polysaccharide gelling material, such as carrageenan, alginic acid, gellan gum, curdlan or the like.

(Soybean Protein Material)

In the present invention, a soybean protein material containing soybean protein is particularly preferable as the gelling material because it has freezing resistance after gelling Specifically, examples of the soybean protein material include whole soy milk, defatted concentrated soy milk, concentrated soybean protein, isolated soybean protein, soybean protein fractions, etc. When these are used, smooth swallowing can be maintained even after freezing or thawing. An isolated soybean protein, extracted with chloroform and methanol (2:1) and having a low fat content (having a low content of lipophilic protein and rich in soybean globulin) is more preferable because it has a good flavor and a transparent feeling. For example, if isolated soybean protein is used, it preferably has a fat content of 3.6 wt % or less, and more preferably 1.2 wt % or less. This isolated soybean protein has a good flavor or a transparent feeling. For example, a soybean protein material having an LCI value of 38% or less, such as that defined in Japanese Unexamined Patent Application Publication No. 2010-193909, is most preferably used as a soybean protein material rich in soybean globulin. In addition, the use of a soybean protein material containing a soybean protein that does not have a thermal history of 80° C. or higher (that is, intact or only partially denatured) in a water system is preferable because it has a low viscosity even at the same concentration, an oil-in-water-type emulsion slurry is obtained even at a high solid content, and the chewing taste (breaking stress) of the gel food is increased.

(Oil and Fat)

Oil and fat may be selected from among edible oils and fats by taking into account supply stability, economic efficiency, nutritive properties, physiological functionality, qualities, such as texture, flavor, color, and/or the like. For example, vegetable oils and fats, such as corn oil, rapeseed oil, safflower oil, sunflower seed oil, soybean oil, rice bran oil, olive oil, sesame oil, peanut oil, palm oil, palm kernel oil, coconut oil, cacao butter, etc., oils of fishes, such as oils of mackerel, sardine, saurel, tuna, codfish, shark, etc., oils and fats of marine organisms, such as cuttlefish oil and whale oil, oils and fats of land animals, such as lard, tallow, milk fat, etc., oils and fats derived from algae or microorganisms, and their hydrogenated oils, fractionated oils and transesterified oils, etc., may be used alone or in combination. In contrast, if oil and fat having a high melting point is used, it will be difficult to feel the oozing of oil at the temperature of the food, and thus the added oil and fat preferably has a low melting point. Particularly, the melting point is preferably 30° C. or lower, more preferably 20° C. or lower, and most preferably 10° C. or lower. With respect to the kind of raw material, vegetable oil or fish oil is preferably used. Specifically, corn oil, rapeseed oil, safflower oil, sunflower seed oil, soybean oil, rice bran oil, etc., may be used. Furthermore, it is also preferable to use olive oil or palm olein oil having a low content of polyunsaturated fatty acids, sunflower seed oil or safflower oil having a high oleic acid content, etc. Furthermore, compositions containing other materials, such as margarine, shortening, chocolate, etc., may also be used as long as they do not interfere with the oozing of oil. Moreover, an open-tube melting point described in Standard Test Method for Analysis of Oil and Fat (1) 1996 version (established by the Japanese Oil Chemistry Society) 2.2.4.2-1996 was used as the melting point.

(Oil-in-Water-Type Emulsion Slurry and Slurry Oil Droplet Content)

The oil-in-water-type emulsion gel food of the present invention is obtained by gelling an oil-in-water emulsion slurry that is prepared by adding the above-mentioned oil and fat to an aqueous solution of the above-described gelling material and applying a suitable shear force thereto. It is important that the content of oil droplets having a particle diameter of 50-800 nm in the slurry mixture (slurry oil droplet content) is 10-60 wt %. The content of the oil droplets is preferably 20-55 wt %, and more preferably 30-50 wt %. If the content of oil droplets is less than 10 wt %, it will be difficult to feel the oozing of oil and fat from the gel food that is prepared later. If the content is more than 60 wt %, it will be difficult to maintain oil droplets in the gel. In the present invention, the “particle diameter of oil droplets” is a particle diameter obtained by measuring the diameter of oil droplets in the emulsion slurry using a particle size distribution analyzer, and is measured in the following sequence. The particle diameter of oil droplets is measured by adding 40 ml of glycerin to 10 ml of a solution obtained by diluting a sample emulsion with water at 1:20 (v/v), placing the resulting solution in a test tube (50 ml conical tube manufactured by Thermo Scientific, Inc.), covering the tube with a cover, mixing the solution in a manner that prevents the production of bubbles to prepare a sample solution for measurement, and measuring the particle diameter of oil droplets in the sample solution with a laser diffraction particle size distribution analyzer (SALD-2000J manufactured by Shimadzu Corp.). The particle size distribution is also measured according to the manual. The sample solution is diluted with 80 (v/v) % glycerin solution so that it reaches the measurement absorbance range (OD: 0.05-0.2). Centering adjustment and blank measurement are performed by 80 (v/v) % glycerin solution, and the refractive index parameter is measured according to the “low refractive index (polymer material, etc.): 1.60-0.10i” of the manual. As a distribution criterion in output conditions of particle size distribution data, “volume” is selected. The content (wt %) of oil droplets for each particle diameter range is calculated by multiplying the particle amount frequency (%) for each of obtained particle diameters by the oil and fat content of the emulsion slurry. The contents of oil droplets in the particle diameter in the range from 50 μm to 800 μm are integrated, and the integrated value is regarded as the content (wt %) of slurry oil droplets having a particle diameter of 50-800 μm.

(Oil-in-Water-Type Emulsion Gel Food)

The oil-in-water-type emulsion gel food of the present invention is obtained by gelling the above-described oil-in-water-type emulsion slurry with the gelling material contained in the slurry. The content of oil and fat in the gel food is preferably more than 10 wt % and equal to or less than 60 wt %. If the content of oil and fat in the gel food is 10 wt % or less, it will difficult to feel the oozing of oil and fat. In contrast, if the content is more than 60 wt %, it will be difficult to maintain oil droplets in the gel. In addition, it is required that oil and fat is present as an oil-in-water-type emulsion. In the case of a water-in-oil-type emulsion, gel grains or aggregates occur in liquid oil or solid fat, so that oil is already separated before mastication, and thus it is difficult to achieve the object of the present invention. In order to increase the feeling of the oozing of oil and fat, the content of oil and fat in the gel food is preferably 20 wt % or more, more preferably 30 wt % or more, even more preferably 40 wt % or more, and most preferably 55 wt % or less.

(Plane Occupancy Ratio of Oil Droplets)

It is important that the plane occupancy ratio of oil droplets having a diameter of 50-800 μm in the oil-in-water-type emulsion gel food of the present invention is 10-60%. Also, the plane occupancy ratio is preferably 10-50%, and more preferably 11-45%. In some cases, a plane occupancy ratio of 20-40% may be more preferable. Oil droplets having a diameter of less than 50 μm will have a low effect on the oozing of oil and fat, and oil droplets having a diameter of more than 800 μm will be unstable and may be separated before mastication in some cases. If the plane occupancy ratio of oil droplets having the above-described particle diameter is less than 10%, the oozing of oil and fat cannot be felt. In contrast, if it is more than 60%, oil droplets in the gel cannot be maintained. The plane occupancy ratio of oil droplets having a diameter of 80-500 μm is preferably 3-50%, more preferably 5-40%, and most preferably 10-30%.

In the present invention, the “diameter of oil droplets” is the oil droplet diameter determined by observing the cross section of a sample with an optical microscope, and is measured in the following manner. First, digital microscope “VHX-600” manufactured by Keyence Corp. is equipped with a genuine lens “VHZ-100,” the mode thereof is adjusted to light transmission mode, and the magnification is adjusted to 200×. A sample, adjusted to 20° C. and sliced to a thickness of about 300 μm, is placed on slide glass without a cover glass, and oil droplets are observed. A 100 μm scale is provided within a visual field, and then the observed image is obtained. For each oil droplet on the observed image, any side of a rectangular image frame line is selected as a reference, and the width of each oil droplet as a line segment parallel to the reference side is measured and regarded as the diameter of each oil droplet.

In this case, the “plane occupancy ratio” is the percentage of an area occupied by oil droplets having a specific diameter relative to a predetermined area in the above-described optical microscopic observation. In this case, for a plurality of oil droplets that at least partially overlap one another in the visual field, oil droplets having large areas are preferred, and other oil droplets that partially overlap the preferred oil droplets are not integrated. The total area of oil droplets having a specific diameter in the predetermined area, calculated as described above, is calculated as the plane occupancy ratio.

(Shape-Retaining Property)

The oil-in-water-type emulsion gel food of the present invention does not include a liquid or paste phase food that does not have a shape-retaining property. It is preferred that the gel food has a shape-retaining property and an oil-holding property before mastication and loses an oil-holding property through mastication. It is preferable that dripping indicating that a liquid, such as water, oil and fat, or an oil-in-water emulsion, leaks from the gel food before mastication, is low. In this case, the shape-retaining property can be expressed as “breaking stress.” Specifically, a sample, adjusted to any one higher temperature of 20° C. and the melting point of the oil and fat contained in the gel, is formed to have a diameter of 30 mm or more and a thickness of 20 mm. A sample having a thickness smaller than 20 mm is formed to have a thickness of 20 mm by lamination. The load at which the sample is broken using a spherical plunger (φ 5 mm) at a speed of 1 mm/sec is measured by “RHEONER33005” manufactured by Yamaden Co., Ltd., and the average value of three measurements is recorded as breaking load (F·gf). If the breaking point is unclear, the maximum load in the range up to the point at which the sample is compressed by 95% is regarded as the breaking load. Based on the obtained breaking load (F·gf) and the plunger radius (R·mm), the breaking stress is calculated using the following equation:

Breaking stress (N/m²)=F×9.8÷(R×R×3.14)×1000

In order for the shape-retaining property before mastication to be sufficiently secured, the breaking stress is preferably 3,000 N/m² or higher. If the food has a breaking stress higher than 60,000 N/m², it will be difficult to feel the oozing of oil and fat, as described below. Accordingly, the breaking stress is preferably 3,000-60,000 N/m². In this breaking stress range, the food can be designed such that the oozing of oil and fat during mastication is felt, and the quality of the gel or the smoothness of swallowing can be adjusted by the kind of gelling material or the melting point of oil and fat. In this case, a wide variety of foods can be obtained by appropriately selecting the color, flavor or like of the sample. Thus, it is possible to adjust the color or flavor of foods such that the foods are evaluated as different even when they have the same breaking stress. Although the application of foods also vary depending on the amount or kind of oil and fat, examples of breaking stress for obtained foods include 3,000-10,000 N/m² for “soft fat-type foods,” 10,000-30,000 N/m² for “fat-type foods that are neither soft nor hard,” 30,000-50,000 N/m² “hard fat-type foods,” 35,000-40,000 N/m² for “raw fish and shellfish meat-type foods,” 30,000-50,000 N/m² for “raw liver-type foods,” 40,000-60,000 N/m² for “sausage-type foods,” 25,000-40,000 N/m² for “sweet rice jelly-type foods,” 20,000-30,000 N/m² for “soft hanpen-type foods,” 5,000-15,000 N/m² for “freeze-dried tofu-type foods,” and 3,000-10,000 N/m² for “highly nutritive food for very old persons having reduced mastication and swallowing abilities.”

(Oozing of Oil and Fat)

The oozing of oil and fat from the food during mastication is important to the present invention. Although this property is generally evaluated by sensory evaluation, it may be evaluated as a physical value, which is the ratio of the dry weight of a squeezed liquid to the weight of the gel in a squeezing test, that is, the percentage of a squeezed liquid. Specifically, this property indicates the percentage of the dry weight of a squeezed liquid, such as oil and fat or water, which oozes into filter paper when a sample is squeezed, relative to the weight of the sample before squeezing, and it is measured in the following sequence. φ9 cm filter paper (“Filter Paper (No. 2)” manufactured by Advantec Toyo Corp.) is dried at 105° C. for 24 hours, weighed and folded in half, about 200 mg of a square sample cut to a thickness of 2 mm is placed at the center of the filter paper, and the weight of the sample is measured. The filter paper is bent along the folded mark to softly enclose the sample, placed in a three-side sealed flat bag (“a heat-resistant bag NCF/12 cm width” manufactured by COW PACK Co., Ltd.), sealed under a pressure of −0.95 bar, and allowed to stand for 1 hour under atmospheric pressure at any one higher temperature of 20° C. and the melting point of oil and fat contained in the gel. After opening, the sample is removed from the filter paper, and the filter paper containing a “squeezed liquid” is dried at 105° C. for 24 hours. The amount of the dry weight of the liquid that oozed into the filter paper is measured, and expressed as a percentage relative to the mass of the sample measured at the start of the test. In the present invention, the rate of the squeezed liquid is preferably 10-60 wt %. If the rate of the squeezed liquid is less than 10 wt %, the mastication property will be reduced. In contrast, if it is more than 60 wt %, the texture of the food will be reduced because the amount of oil and fat is excessively large. For a crosslinked gel of soybean protein, the rate of the squeezed liquid is more preferably 10-30 wt %, and most preferably 15-25 wt %.

(Swallowing Property)

In the present invention, the “swallowing property” refers to the smoothness of swallowing, and is evaluated by sensory evaluation. In addition to the oozing property of oil and fat, the swallowing property is important to the present invention. Although the oozing property of oil and fat is also associated with the diameter of oil droplets, the swallowing property is associated with not only the diameter of oil droplets but also the kind of gelling material. It is preferred that the breaking stress is as high as 3,000-60,000 N/m² as described below and the gel having a bending texture has a continuous phase. It is effective that the gelling material is selected from this viewpoint. As described above, the continuous layer of the gel in the oil-in-water-type emulsion gel food is preferably a gel of soybean protein or gelatin. The continuous layer of the gel is preferably a protein gel having an intermolecular bridge catalyzed by a crosslinking enzyme.

(Protein Crosslinking Enzyme)

The gel food of the present invention is preferably a gel formed not only by hydrogen bonding between the molecules of the gelling material but also by another type of bonding, that is, ionic bonding via metal ions, such as Ca, etc., or bonding based on hydrophobic affinity between protein molecules, or is preferably a gel polymerized by covalent bonding between protein molecules. In addition, it is preferably a gel having an intermolecular bridge catalyzed by a protein crosslinking enzyme. Transglutaminase is the most preferable as the protein crosslinking enzyme in light of workability attributable to easy reaction, the cost for preparation of the gel, and the suitability of texture, such as the oozing of fat from the prepared gel or the swallowing property of the gel. With respect to the type of transglutaminase and a method using the same, for example, 0.1-10 parts by weight (preferably 0.3-3.0 parts by weight, depending on the process) of a 10% aqueous solution of an Activa TG-S formulation (manufactured by Ajinomoto Co., Inc.; 100 units of inactive transglutaminase/g of formulation) is added to 100 parts by weight of an oil-in-water emulsion slurry having a soybean protein concentration of 5-15 wt % with respect to each defatted slurry. In addition, when the gelling material is soybean protein, transglutaminase is particularly effective.

(Preparation Method)

For the gel food of the present invention, a preparation method that uses a soybean protein material as a gelling material is illustrated Although whole soy milk, defatted concentrated soy milk, concentrated soybean protein, isolated soybean protein, soybean protein fractions, etc. may be used as the soybean protein material, an isolated soybean protein prepared by extracting soy milk from defatted soybeans, collecting a protein component from the soy milk by isoelectric point precipitation or membrane separation and then using the protein component intact or neutralizing the protein component is preferable. An isolated soybean protein obtained from slightly denatured soybeans having a protein dispersibility index (PDI) of 40-80 is particularly preferable because it has a high soybean globulin content. Adjustment of PDI may be performed using a method described in Japanese Unexamined Patent Application Publication No. 2010-193909, etc. For example, isolated soybean protein can be obtained from defatted soybeans that are obtained by heating soybeans at a temperature of 60-95° C. for about 1 minute to 10 hours in an atmosphere with a relative humidity of 90% or higher. Then, this soybean protein material is prepared as an aqueous solution, but the concentration of soybean protein in the aqueous solution is preferably 5-15 wt %, more preferably 7-14 wt %, and most preferably 9-12 wt %. If the concentration of soybean protein is lower than 5 wt %, it will be slightly difficult to form a gel. In contrast, if the concentration is higher than 15 wt %, it will be slightly difficult to form oil droplets. The viscosity of the aqueous solution of soybean protein at 55° C. is preferably 5,500 mPa·s or less, more preferably 3,000 mPa·s or less, and most preferably 100-2,000 mPa·s, regardless of whether it is used in combination with other gelling materials. If the viscosity is out of this range, it will be difficult to prepare an oil-in-water-type emulsion gel having a specific oil droplet diameter. Here, in the present invention, the “viscosity” is the viscosity of a sample at 55° C., which is measured using a type B viscometer (“model BM” manufactured by Tokyo Keiki Inc.). In this case, the number of revolutions per minute of the rotor of the viscometer is set to 30 rpm, and the rotor is shifted in the order of Nos. 4321 during measurement, and each measurement value at 30 seconds after the start of rotation is recorded. Among the obtained results, in a measurable range (from 1 to 100 gradations), the measurement values of the rotor having the smallest number (the largest rotor) are used. If the viscosity is high and measured to be above 20,000 mPa·s by using No. 4 rotor, measurement is performed at 6 rpm.

An aqueous solution of protein is preferably adjusted to 40-60° C. In this case, if an aqueous solution having a high protein concentration is used, the breaking stress, etc. of the gel food can be increased, but the aqueous solution having a high protein concentration will have a high viscosity and it will be difficult to control the particle diameter of oil and fat. Accordingly, when the temperature of the aqueous solution is increased in a range that does not influence the thermal denaturalization of protein, the viscosity of the solution can be reduced, thereby obtaining the present invention having a desired particle diameter and a high breaking stress. However, if an already thermally denatured protein is used, it may be gelled (non-flowable) in some cases when it is allowed to stand at 40-60° C., in which case it is preferable to use it at 15-25° C. without elevating the temperature. The oil and fat added is preferably used at a temperature equal to or higher than the melting point thereof in order to ensure dispersibility. For this purpose, the oil and fat is preferably adjusted at 40-60° C. as in the aqueous solution of protein, and is mixed with the aqueous solution of protein at 40-60° C.

In an example of a specific operation, 25-150 parts by weight of oil and fat is added to 100 parts by weight of an aqueous solution of soybean protein while they are being stirred, and also treatment with transglutaminase is performed. In this case, the treatment with transglutaminase is preferably performed at 15-65° C., and more preferably 45-55° C., in light of the optimum reaction temperature and activation temperature of transglutaminase. If thickening of the slurry is disadvantageous in terms of filling workability, the treatment with transglutaminase is preferably performed at 15-25° C., which is lower than the optimum reaction temperature. For example, when an aqueous dispersion of powdery soybean protein is used, the treatment with transglutaminase is preferably performed at 15-25° C. The aqueous solution of protein and the oil and fat are preferably mixed with stirring, and weak stirring with propellers may be illustrated as a preferred method. The “weak stiffing” refers to stirring at a linear velocity of a propeller tip of about 30-3,000 cm/sec for 1-300 seconds. When a baffle plate is removed such that micro-emulsification do not easily occur, even weak stirring using a homomixer, etc. is possible. Meanwhile, strong stirring with a homogenizer or the like suitable for forming a micro-emulsified state is not very suitable in the present invention. The method for preparing the gel food may be performed in a batch-type fashion. In addition, if an oil layer and a water layer are produced in a batch-type process, they may be collected and mixed again such that an oil droplet layer can be formed. A continuous system may also be selected.

When the soybean protein contained in raw soybean protein material has no thermal history of 80° C. or higher in a water system, it is preferable because the breaking stress can be increased. As the soybean protein material serving as a gelling material, a low-viscosity enzyme-degraded protein, a peptide, or the like may be used in a range in which the physical properties of the gel are secured after heating. In addition, by using it in combination with other gelling materials, such as egg protein, which have a low density and a high gelling property, the viscosity of solids in the gelling material solution can be lowered, thereby increasing breaking stress or reducing breaking deformation. The pH of the aqueous solution of soybean protein is preferably 5.5-9.5, and more preferably 6.5-7.5, in light of a water-holding property and the like. When the gel is frozen, the protein can be partially frozen and denatured, and thus the palate feeling of the gel food can be complicated (hetero). When the hetero palate feeling is desired to be more emphasized, it is effective to add hydrochloric acid, calcium sulfate, or a coagulant for bean-curd to the slurry to adjust the pH to 6.0-6.5 and then gel it, or to bring a gel prepared to have a pH of 6.5-7.5 or the like into contact with a high-salt solution, such as soy source or the like, or a low-pH solution, such as vinegar or the like.

(Preservation)

The gel food of the present invention is preferably a heat-sterilized food. With respect to the conditions of heating, heating at 80-150° C. for a few seconds to 90 minutes, etc., may be illustrated as an example. In addition, retort sterilization or the like may also be performed. Depending on the intended use or sterilization conditions, freeze, chilled or room temperature preservation can be selected. A retort-sterilized food for room temperature preservation or a heat-sterilized food for freeze preservation is preferable.

(Measurement of Content of Oil and Fat in Gel)

The “content (wt %) of oil and fat in the gel” is measured by the Improved Extraction Method with Chloroform Methanol (hereinafter abbreviated as “chlometha method”) described in the STANDARD TABLES OF FOOD COMPOSITION IN JAPAN, 5^{th} revised and enlarged edition (the Ministry of Education, Culture, Sports, Science and Technology, JAPAN).

(Measurement of PDI)

By using a drink master blender (model 936-2; Hamilton Beach), 20 g of a sample and 300 ml of distilled water were mixed at 25° C. at 8,500 rpm for 10 minutes. Then, the slurry was centrifuged at 2,700 rpm for 10 minutes, 15 ml of the supernatant was transferred into a Kjeldahl tube by a pipette, and the amount of nitrogen therein was determined by the Kjeldahl method according to AOCS-authorized procedure Aa 5-91 or AOCS-authorized procedure Ba4d-90.

PDI:(B−S)×N×0.014×100×6.25×100/% total protein amount
B: amount (ml) of droplets in blank in the Kjeldahl method
S: amount (ml) of droplets in sample in the Kjeldahl method
N: normality of alkali used in the Kjeldahl method

(General Components)

General components are analyzed by the method described in the food component table. Water is analyzed using a direct method, protein is analyzed using an improved Kjeldahl method, fat is analyzed using an improved extraction method with chloroform methanol, carbohydrate is analyzed using a subtraction method, and ash is analyzed using a direct ashing method. In addition, the nitrogen-protein conversion factor used in calculation is 6.25.

(Mastication Test)

In a mastication test, two items, “feeling of oozing of oil and fat during mastication” and “swallowing”, are evaluated by five panelists. The results of the evaluation of the “feeling of oozing of oil and fat during mastication” are evaluated as: “⊚” for a case where 5 panelists answer that this feeling is good; “o” for a case where a case where 3-4 panelists answer that this feeling is good; “Δ” for a case where 1-2 panelists answer that this feeling is good; and “x” for a case where none of the panelists answer that this feeling is good. These results are interpreted as follows: ⊚: oozing of oil and fat is very much felt; o: oozing of oil and fat is much felt; Δ: oozing of oil and fat is slightly felt; and x: oozing of oil and fat is not felt. In addition, the results of the evaluation of “swallowing” are evaluated as: “⊚” for a case where 5 panelists answer that swallowing is smooth; “o” for a case where 3-4 panelists answer that swallowing is smooth; “Δ” for a case where 1-2 panelists answer that swallowing is smooth; and “x” for a case where none of the panelists answer that swallowing is smooth. These results are interpreted as follows: ⊚: swallowing is very smooth; o: swallowing is sufficiently smooth; Δ: swallowing is slightly smooth; and x: swallowing is not smooth. During the mastication test, the “texture” and “color” of the gel food are evaluated by the panelists, and comments obtained by agreement between 3 or more panelists are recorded.

(Processed Foods Using Gel Food as Raw Material)

The oil-in-water-type emulsion gel food of the present invention may be used alone or in combination with other food materials in various uses. In the preparation of the gel, the content or composition of oil and fat, the kind of gelling material, seasoning, pigment and spices, etc. may be appropriately selected, so that the gel may be used in fat-type foods, raw fish and shellfish meat-type foods, raw liver-type foods, sausage-type foods, sweet rice jelly-type foods, soft hanpen-type foods, freeze-dried tofu-type foods, etc. In addition, the prepared gel food may be combined with other materials, thereby preparing Sushi, highly nutritive gel foods, snack, toppings, seasonings, dessert, or highly nutritive food for very old persons having reduced mastication and swallowing abilities.

### Examples

Hereinafter, the present invention will be explained by describing examples.

(Preparation of Gelling Materials)

### Preparation Example 1

### Preparation of Isolated Soybean Protein a Having High Physical Properties

1 part by weight of defatted soybeans (PDI: 83) were added to 13 parts by weight of water (pH 6.7) and centrifuged to remove bean-curd dregs and collect a soluble fraction. The protein that was precipitated by adjustment to pH 4.5 was collected by centrifugation and neutralized, thereby obtaining isolated soybean protein A (solution A). Solution A had a protein content of 96.3% and a fat content of 1.4% based on the solid content. A portion of solution A was frozen (frozen product A, solid content: 14.2%), a portion of the remaining solution A was spray-dried (powder product A (unsterilized), solid content: 94.0%) without heat sterilization, and the remainder was spray-dried after heat sterilization (powder product A; solid content: 94.0%; LCI value: 37).

### Preparation Example 2

### Preparation of Isolated Soybean Protein Having Low Oil Content

1 part by weight of defatted soybeans (PDI: 66) were added to 15 parts by weight of water (pH 6.4), and isolated soybean protein B (solution B) was obtained in the same manner as described in Preparation Example 1. Solution B had a protein content of 93.3% and a fat content of 0.8% based on the solid content. A portion of solution B was frozen (frozen product B, solid content: 16.5%), and the remainder was spray-dried after heat sterilization (powder product B, solid content: 94.0%, LCI value: 33).

### Example 1

### Fat-Type Food Using Soybean Protein Having High Physical Properties

60 parts by weight of a diluted/thawed product (protein concentration: 12.5 wt %; 2,300 mPa·s) obtained from isolated soybean protein (frozen product A) was elevated to 55° C., 40 parts by weight of rapeseed oil (“refined rapeseed oil” manufactured by Fuji Oil Co., Ltd.) was injected along the shaft of a propeller at 55° C. while the mixture was being stirred with the propeller at 600 rpm, and the mixture continued to be stirred at 600 rpm for 1 minute, thereby obtaining an oil-in-water-type emulsion slurry. After the particle size distribution of the slurry was measured, 1 wt % of a crosslinker solution (“Activa TG-S” 10% aqueous solution of 100 units of transglutaminase/g manufactured by Ajinomoto Co., Inc.) was added to the slurry, and the mixture was filled into a heat-resistant bag, reacted enzymatically at 55° C. for 30 minutes and sterilized at 90° C. for 30 minutes. Heat was removed with running water, the sterilized material was frozen overnight at −20° C., and the frozen material in the bag was thawed with running water before various analyses or testing, thereby preparing a sample. The composition and preparation method of the sample and the correlations between the oil droplet diameter and the texture are shown in Tables 1 and 2 below. The obtained sample had a hard fat-like texture and a semi-transparent yellowish white color. In a mastication test for the sample, the oozing of oil and fat from the sample during mastication could be much felt, and swallowing of the sample was sufficiently smooth.

### Example 2

### Fat-Type Food Using Soybean Protein Having Low Oil Content

In place of isolated soybean protein (frozen product A), a diluted/thawed product (protein concentration: 8.4 wt %; 230 mPa·s) obtained from isolated soybean protein (frozen product B) was used. 1.2 parts by weight a natural pigment (a 9:1 mixture of monascus pigment “Monascolor 300 LD” manufactured by Glyco Nutrition Food Corp. and purple sweet potato pigment “San Red YMF” manufactured by Sun Red YMF (San-Ei Gen F.F.I., Inc.)) was added thereto, and then the same operation as described in Example 1 was performed. The obtained sample had a soft fat-like texture and an approximately transparent dark red color. In a mastication test for the sample, the oozing of oil and fat from the sample during mastication could be very much felt, and swallowing of the sample was very smooth.

### Example 3

### High-Temperature Sterilization

In place of rapeseed oil, a sesame oil mixture (a 2:1 mixture of “pure sesame oil” manufactured by Kadoya Sesame Mills Inc. and “Taihaku sesame oil” manufactured by Takemoto Oil & Fat Co., Ltd.) was used. The natural pigment described in Example 2 was added thereto, and the same operation as described in Example 1 was performed. Sterilization was performed in a retort sterilizer (manufactured by Hisaka Works, Ltd.) at 121° C. for 10 minutes. The obtained sample had a raw liver-like texture and a semi-transparent dark red color. In a mastication test for the sample, the oozing of oil and fat from the sample during mastication could be slightly felt, and swallowing of the sample was slightly smooth.

### Example 4

### Commercial Soybean Protein Solution

In place of isolated soybean protein (frozen product A), an aqueous solution of isolated soybean protein (New Fujipro E; LCI value: 39) (protein concentration: 10.3 wt % (1,060 mPa·s); 91.2% protein content and 4.5% fat content based on the solid content) was used. In place of rapeseed oil, olive oil (“extra virgin olive oil” manufactured by CIRIO) was used. For the isolated soybean protein solution (20° C.) and the olive oil (20° C.), the same operation as described in Example 1 was performed without elevation to 55° C. before mixing. The obtained sample had a soft fat-like texture and an opaque yellowish white color. In a mastication test for the sample, the oozing of oil and fat from the sample during mastication could be very much felt, and swallowing of the sample was sufficiently smooth.

### Comparative Example 1

### High-Shear Stirring/Small Oil Droplet Diameter

The same operation as described in Example 1 was performed. However, the solution was stiffed with a homogenizer (Excel Auto Homogenizer DX-8 manufactured by Nippon Seiki Co., Ltd.) at 12,000 rpm in place of the propeller. Oil was injected, and the solution continued to be stirred for 3 minutes. The obtained sample had a soft fish cake-like texture and an opaque turbid white color. The slurry before gelling and the gel had a small oil droplet diameter. In a mastication test for the sample, the oozing of oil and fat from the sample during mastication could not be felt, and swallowing of the sample was not smooth.

### Comparative Example 2

### Low Oil Content

The same operation as described in Example 1 was performed. However, the soybean protein solution and the oil and fat were mixed at a weight ratio of 90:10 in place of 60:40. The obtained sample had a soft konjac-like texture and a semi-transparent yellowish white color. In a mastication test for the sample, the oozing of oil and fat from the sample during mastication could not be felt due to its original low oil content, and swallowing of the sample was not smooth.

### Example 5

### Egg White

In place of isolated soybean protein (frozen product A), a raw egg white solution (protein concentration: 10.5 wt %) was used. The same operation as described in Example 1 was performed. The obtained sample had a freeze-dried tofu-like texture and an opaque turbid white color. In a mastication test for the sample, the oozing of oil and fat from the sample during mastication could be very much felt, and swallowing of the sample was slightly smooth.

### Example 6

### Egg White

The same operation as described in Example 5 was performed. However, in place of the propeller, a homomixer (T. K Homomixer TYPE-M manufactured by Tokushu Kika Co., Ltd.) was used. Oil was injected slowly while the solution was being stirred with the homomixer at 3,000 rpm, and the solution continued to be stirred for 0.3 minutes. The obtained sample had a hanpen-like texture and an opaque turbid white color. In a mastication test for the sample, the oozing of oil and fat from the sample during mastication could be very much felt, and swallowing of the sample was slightly smooth.

### Comparative Example 3

### Egg White/High-Shear Stirring

The same operation as described in Example 6 was performed. However, the number of revolutions per min of the homomixer was as high as 6,000 rpm. The obtained sample had an egg white gel-like texture and an opaque turbid white color. In a mastication test for the sample, the oozing of oil and fat from the sample during mastication could not be felt due to the small oil droplet diameter of the slurry before gelling or gel, and swallowing of the sample was not smooth.

### Comparative Example 4

### Non-Crosslinking of Soybean Protein

In place of isolated soybean protein (frozen product A), a diluted/thawed product (protein concentration: 8.4 wt %; 230 mPa·s) of isolated soybean protein (frozen product B) was used. The same operation as described in Example 1 was performed. However, the crosslinker solution was not added, and heating (at 55° C. for 30 min) was omitted. The obtained sample had no shape-retaining property before mastication because gelling attributable to crosslinking was not sufficiently performed, and it also had no oil-holding property. When the sample was taken out of the bag, it has a semi-solid phase and thus no shape-retaining property, so that the desired oil-in-water-type emulsion gel having a high oil content was not obtained.

### Example 7

### Gelatin

The same operation as described in Example 1 was performed. In the place of isolated soybean protein A (frozen product A), an aqueous solution (protein concentration: 16.0 wt %; 130 mPa·s) of commercial gelatin (Newsilver Granule manufactured by Nitta Gelatin Inc.) was used, and, in place of a rapeseed oil, a sesame oil (a “Taihaku sesame oil” (100%) manufactured by Takemoto Oil & Fat Co., Ltd.) was used. When sterilization (at 90° C. for 30 min) was performed, about 20% of the whole dough was settled down as a gelatin layer having no oil droplet, and thus the oil-in-water emulsion layer was selected for evaluation. When the sample was frozen or thawed, it had a prickly poor texture. Accordingly, the sample was not frozen, but was cold-stored. The obtained sample had a sweet rice jelly-like texture and an approximately transparent yellowish white color. In a mastication test for the sample, the oozing of oil and fat from the sample during mastication could be slightly felt, and swallowing of the sample was very smooth.

### Example 8

### Semi-Solid Fat

In place of rapeseed oil, semi-solid palm oil (manufactured by Fuji Oil Co., Ltd.; “fined palm oil”; open-tube melting point: 37° C.) was used at room temperature (20° C.). The same operation as described in Example 1 was performed. The solution was cold-stored without freezing, and elevated to 40° C., thereby obtaining a sample. The obtained sample had a sausage-like texture and an opaque turbid white color. In a mastication test for the sample, the oozing of oil and fat from the sample during mastication could be slightly felt, and swallowing of the sample was slightly smooth.

### Example 9

### Mixture

169 parts by weight of isolated soybean protein (frozen product A; solid content: 14.2%; protein concentration: 13.7 wt %) was thawed, and 0.5 parts by weight of the natural pigment (described in Example 2) and 71 parts by weight of water were added thereto and mixed (protein concentration: 9.6 wt %). The mixture was elevated to 55° C., and 2.4 parts by weight of the crosslinker solution (described in Example 1) was added thereto. The resulting mixture was filled into a heat-resistant bag, heated (at 55° C. for 30 min), sterilized (at 90° C. for 30 min), cold-stored overnight (5° C.), and then comminuted with a robot-coupe (for 30 seconds with scratching out), thereby obtaining a low-oil-content food material (part I). Meanwhile, 220 parts by weight of isolated soybean protein (frozen product A; solid content: 14.2%; protein concentration: 13.7 wt %) was thawed, and 2.0 parts by weight of the natural pigment (described in Example 2), 0.48 wt % of calcium sulfate (Kishida Chemical Co., Ltd.; food additive grade), 0.1 parts by weight of hydrochloric acid and 20 parts by weight of water were added thereto. The mixture (protein concentration: 12.4 wt %) was stirred and then elevated to 55° C. (pH 6.5), and 160 parts by weight of rapeseed oil (55° C.) was injected slowly while the solution was being stirred with a propeller (600 rpm). The resulting mixture was stirred with a propeller at 600 rpm for 1 minute, thereby obtaining an oil-in-water-type emulsion slurry. 243 parts by weight of the food material (part I) was added to 403 parts by weight of the water-in-oil emulsion slurry, and 4.0 parts by weight of the crosslinker solution described in Example 1 was added thereto. The resulting mixture was debubbled under reduced pressure (−0.95 bar), filled into a heat-resistant bag, heated (at 55° C. for 30 min), and sterilized (at 90° C. for 30 min) Heat was removed from the sterilized mixture with running water, and then the mixture was freeze-stored at −20° C. for 6 weeks and thawed with running water, thereby obtaining a sample comprising the food material scattered in oil-in-water gel. The obtained sample had a raw fish and shellfish meat-like texture and a semi-transparent dark red color. In a mastication test for the sample, the oozing of oil and fat from the sample during mastication could be much felt, and swallowing of the sample was sufficiently smooth.

The slurry oil droplet content before gelling, the plane occupancy ratio after gelling, and the results of the mastication test, together with the preparation conditions, are summarized as follows. It was shown that the gel did not have the oozing property when the content of the slurry oil droplets having a particle diameter of 50-800 μm was 10% or less and the gel had the oozing property only when the oil droplets having a particle diameter of 50-800 μm had a plane occupancy ratio of more than 10%. Meanwhile, these gels had a breaking stress of 3,000-60,000 N/m² and a shape-retaining property. With respect to swallowing, not only the content of the oil droplets having a particle diameter of 50-800 μm, but also the kind of gelling material were associated with swallowing, and a soybean protein material or gelatin was preferred as the gelling material.

TABLE 1
Oil-in-water-type emulsion gel according to each material and preparation method

| | | | | Oil | | | | | |
|---|---|---|---|---|---|---|---|---|---|
| | | Protein | Liquid | and | Kind of | | Stirring | | |
| | Gelling | conc. | viscosity | fat % | oil and | Stirring | conditions | Crosslinking | Sterilization |
| | material | (wt %) | (mPa · s) | (wt %) | fat | method | (rpm × min) | enzyme | conditions |
| Ex. 1 | Soybean | 12.5 | 2,300 | 40 | rapeseed | propeller | 600 × 1 | ◯ | 90° C., |
| | (frozen | | | | | | | | 30 min |
| | product A) | | | | | | | | |
| Ex. 2 | Soybean | 8.4 | 230 | ↑ | ↑ | ↑ | ↑ | ↑ | ↑ |
| | (frozen | | | | | | | | |
| | product B) | | | | | | | | |
| Ex. 3 | Soybean | 12.5 | 2,300 | ↑ | sesame | ↑ | ↑ | ↑ | 121° C., |
| | (frozen | | | | | | | | 10 min |
| | product A) | | | | | | | | |
| Ex. 4 | New | 10.3 | 1,060 | ↑ | olive | ↑ | ↑ | ↑ | 90° C., |
| | Fujipro E | | | | | | | | 30 min |
| Ex. 5 | Raw | 10.5 | 780 | ↑ | rapeseed | ↑ | ↑ | ↑ | ↑ |
| | white egg | | | | | | | | |
| Ex. 6 | Raw | ↑ | ↑ | ↑ | ↑ | homomixer | 3,000 × 0.3 | ↑ | ↑ |
| | white egg | | | | | | | | |
| Ex. 7 | Gelatin | 16.0 | 130 | 50 | sesame | propeller | 600 × 1 | ↑ | ↑ |
| Ex. 8 | Soybean | 12.5 | 2,300 | 40 | palm | ↑ | ↑ | ↑ | ↑ |
| | (frozen | | | | | | | | |
| | product A) | | | | | | | | |
| Ex. 9 | Soybean | ↑ | ↑ | 25 | rapeseed | ↑ | ↑ | ↑ | ↑ |
| | (frozen | | | | | | | | |
| | product A) | | | | | | | | |
| Comp. | Soybean | ↑ | ↑ | 40 | ↑ | homogenizer | 12,000 × 3 | ↑ | ↑ |
| Ex. 1 | (frozen | | | | | | | | |
| | product A) | | | | | | | | |
| Comp. | Soybean | ↑ | ↑ | 10 | ↑ | propeller | 600 × 1 | ↑ | ↑ |
| Ex. 2 | (frozen | | | | | | | | |
| | product A) | | | | | | | | |
| Comp. | Raw | 10.5 | 780 | 40 | ↑ | homomixer | 6,000 × 0.3 | ↑ | ↑ |
| Ex. 3 | white egg | | | | | | | | |
| Comp. | Soybean | 8.4 | 230 | ↑ | ↑ | propeller | 600 × 1 | X | ↑ |
| Ex. 4 | (frozen | | | | | | | | |
| | product B) | | | | | | | | |

TABLE 2
Evaluation of each oil-in-water-type emulsion gel

| | | Analytical values | | | | | |
|---|---|---|---|---|---|---|---|
| | | Content | | | | | |
| | | (%) of | 50-800 μm | | | | |
| | | 50-800 μm | plane | Breaking | Percentage of dry | | |
| | Gelling | slurry oil | occupancy | stress | weight of ooze | Sensory evaluation | |
| | material | droplets | ratio (%) | (N/m²) | into filter paper | Oozing | Swallowing |
| Ex. 1 | Soybean | 36.9 | 13.8 | 40,500 | 13 | ◯ | ◯ |
| | (frozen | | | | | | |
| | product A) | | | | | | |
| Ex. 2 | Soybean | 39.9 | 35.6 | 5,050 | 19 | ⊚ | ⊚ |
| | (frozen | | | | | | |
| | product B) | | | | | | |
| Ex. 3 | Soybean | 38.7 | 25.2 | 38,500 | 10 | Δ | Δ |
| | (frozen | | | | | | |
| | product A) | | | | | | |
| Ex. 4 | New | 38.2 | 26.0 | 6,000 | 21 | ⊚ | ◯ |
| | Fujipro E | | | | | | |
| Ex. 5 | Raw | 40.0 | 41.2 | 8,000 | 49 | ⊚ | Δ |
| | white egg | | | | | | |
| Ex. 6 | Raw | 36.0 | 42.6 | 25,300 | 34 | ⊚ | Δ |
| | white egg | | | | | | |
| Ex. 7 | Gelatin | 38.8 | 36.9 | 34,000 | 51 | Δ | ⊚ |
| Ex. 8 | Soybean | 36.3 | 36.4 | 50,500 | 17 | Δ | Δ |
| | (frozen | | | | | | |
| | product A) | | | | | | |
| Ex. 9 | ↑ | 22.0 | 11.9 | 37,000 | 15 | ◯ | ◯ |
| Comp. | ↑ | 0 | 5.8 | 72,000 | 8 | X | X |
| Ex. 1 | | | | | | | |
| Comp. | ↑ | 7.6 | 6.4 | 97,500 | 5 | X | X |
| Ex. 2 | | | | | | | |
| Comp. | Raw | 3.7 | 0 | 21,000 | 8 | X | X |
| Ex. 3 | white egg | | | | | | |

| | | | | |
|---|---|---|---|---|
| Comp. | Soybean | no shape-forming property | not tested | not tested |
| Ex. 4 | (frozen | | | |
| | product B) | | | |

TABLE 3
Slurry oil droplet content (wt %) of each oil-in-water-type emulsion slurry

| | | 0.01- | 0.1- | 1- | 10- | 30- | 50- | 80- | 120- | 200- | 300- | 500- | 800~ |
|---|---|---|---|---|---|---|---|---|---|---|---|---|---|
| | ~0.01 | 0.1 | 1 | 10 | 30 | 50 | 80 | 120 | 200 | 300 | 500 | 800 | (μm) |
| Ex. 1 | 0 | 0 | 0 | 0.4 | 1.2 | 1.5 | 3.7 | 9.1 | 20.4 | 3.1 | 0.6 | 0 | 0 |
| Ex. 2 | 0 | 0 | 0 | 0 | 0 | 0.1 | 1.5 | 14.5 | 23.2 | 0.6 | 0.1 | 0 | 0 |
| Ex. 3 | 0 | 0 | 0 | 0 | 0 | 1.3 | 2.6 | 13.8 | 17.4 | 3.6 | 1.3 | 0 | 0 |
| Ex. 4 | 0 | 0 | 0 | 0.4 | 0.6 | 0.8 | 3.1 | 6.7 | 13.2 | 5.2 | 5.1 | 4.9 | 0 |
| Ex. 5 | 0 | 0 | 0 | 0 | 0 | 0 | 1.0 | 3.6 | 9.8 | 20.7 | 4.6 | 0.3 | 0 |
| Ex. 6 | 0 | 0 | 0 | 0.8 | 1.1 | 2.1 | 5.8 | 10.8 | 15.2 | 3.6 | 0.6 | 0 | 0 |
| Ex. 7 | 0 | 0 | 0 | 2.1 | 3.3 | 5.8 | 17.6 | 16.0 | 4.7 | 0.5 | 0 | 0 | 0 |
| Ex. 8 | 0 | 0 | 0 | 0.4 | 1.0 | 2.3 | 4.1 | 7.4 | 17.3 | 6.3 | 1.2 | 0 | 0 |
| Ex. 9 | 0 | 0 | 0 | 0.4 | 1.0 | 1.6 | 1.9 | 2.9 | 14.3 | 2.3 | 0.6 | 0 | 0 |
| Comp. | 0 | 30.2 | 9.8 | 0 | 0 | 0 | 0 | 0 | 0 | 0 | 0 | 0 | 0 |
| Ex. 1 | | | | | | | | | | | | | |
| Comp. | 0 | 0 | 0 | 0.2 | 1.1 | 1.1 | 1.8 | 3.0 | 2.4 | 0.4 | 0 | 0 | 0 |
| Ex. 2 | | | | | | | | | | | | | |
| Comp. | 0 | 0 | 0 | 6.5 | 11.0 | 18.8 | 3.3 | 0.4 | 0 | 0 | 0 | 0 | 0 |
| Ex. 3 | | | | | | | | | | | | | |

TABLE 4
Diameter distribution of oil droplets in oil-in-water-type emulsion
gel (values in Table 4 are plane occupancy ratios (%))

| | 30-50 | 50-80 | 80-120 | 120-200 | 200-300 | 300-500 | 500-800 | 800~(μm) |
|---|---|---|---|---|---|---|---|---|
| Ex. 1 | 8.1 | 10.4 | 3.4 | 0 | 0 | 0 | 0 | 0 |
| Ex. 2 | 2.5 | 6.8 | 10.1 | 18.7 | 0 | 0 | 0 | 0 |
| Ex. 3 | 6.9 | 17.5 | 7.7 | 0 | 0 | 0 | 0 | 0 |
| Ex. 4 | 4.7 | 11.3 | 3.9 | 4.6 | 6.2 | 0 | 0 | 0 |
| Ex. 5 | 0 | 0.3 | 0 | 3.3 | 6.1 | 18.0 | 13.5 | 0 |
| Ex. 6 | 1.4 | 11.9 | 15.9 | 12.5 | 2.3 | 0 | 0 | 0 |
| Ex. 7 | 0.1 | 0.4 | 2.7 | 9.0 | 14.7 | 10.1 | 0 | 0 |
| Ex. 8 | 3.9 | 10.8 | 15.2 | 10.4 | 0 | 0 | 0 | 0 |
| Ex. 9 | 2.6 | 4.6 | 4.2 | 1.4 | 0.8 | 0.9 | 0 | 0 |
| Comp. | 3.7 | 5.8 | 0 | 0 | 0 | 0 | 0 | 0 |
| Ex. 1 | | | | | | | | |
| Comp. | 1.4 | 3.6 | 2.2 | 0.6 | 0 | 0 | 0 | 0 |
| Ex. 2 | | | | | | | | |
| Comp. | 14.0 | 0 | 0 | 0 | 0 | 0 | 0 | 0 |
| Ex. 3 | | | | | | | | |

### Test Example 1

### Effect of Difference in Particle Diameter on Quality

60 parts by weight of an aqueous solution (20° C.) of isolated soybean protein (“New Fujipro E” manufactured by Fuji Oil Co., Ltd.; LCI value: 39) was mixed with 40 parts by weight of rapeseed oil (20° C.)(“refined rapeseed oil” manufactured by Fuji Oil Co., Ltd.) by stirring with a homogenizer (at 12000 iμm for 3 min), stirring with a homomixer (at 6000 iμm for 1 min), stirring with a propeller (at 600 iμm for 3 min), stirring with a propeller (at 600 iμm for 1 min), or stirring manually with spatula (at 60 rpm for 0.3 min), thereby obtaining oil-in-water-type emulsion slurries. The particle size distributions of the slurries were measured, 1 part by weight of a crosslinker solution (a 10% aqueous solution of “Activa TG-S”, 100 units of transglutaminase/g manufactured by Ajinomoto Co., Inc.) was added to each of the slurries, and each of the slurries was filled into a heat-resistant bag, heated at 55° C. for 30 minutes, and sterilized at 90° C. for 30 minutes. Heat was removed from the slurries with running water, the sterilized slurries were frozen overnight at −20° C., and the frozen slurries in the bag were thawed with running water before various analyses or testing, thereby preparing samples. The results of evaluation of the samples are shown in Tables 5 to 8 below.

TABLE 5
Oil-in-water-type emulsion gel according to each preparation method

| | | | | Oil | | | | | Sterili- |
|---|---|---|---|---|---|---|---|---|---|
| | | Protein | Liquid | and | Kind of | | Stirring | Cross- | zation |
| | Gelling | concentration | viscosity | fat % | oil and | Stirring | conditions | linking | condi- |
| | material | (wt %) | (mPa · s) | (wt %) | fat | method | (rpm × min) | enzyme | tions |
| Test | New | 10.9 | 1,060 | 40 | rapeseed | homogenizer | 12,000 × 3 | ◯ | 90° C., |
| Example | Fujipro E | | | | | | | | 30 min |
| 1-1 | | | | | | | | | |
| Test | ↑ | ↑ | ↑ | ↑ | ↑ | homomixer | 6,000 × 1 | ↑ | ↑ |
| Example | | | | | | | | | |
| 1-2 | | | | | | | | | |
| Test | ↑ | ↑ | ↑ | ↑ | ↑ | propeller | 600 × 3 | ↑ | ↑ |
| Example | | | | | | | | | |
| 1-3 | | | | | | | | | |
| Test | ↑ | ↑ | ↑ | ↑ | ↑ | ↑ | 600 × 1 | ↑ | ↑ |
| Example | | | | | | | | | |
| 1-4 | | | | | | | | | |
| Test | ↑ | ↑ | ↑ | ↑ | ↑ | manual | 60 × 0.3 | ↑ | ↑ |
| Example | | | | | | stirring | | | |
| 1-5 | | | | | | | | | |

TABLE 6
Each oil-in-water-type emulsion gel and evaluation thereof

| | | Analytical values | | | | | |
|---|---|---|---|---|---|---|---|
| | | Content | | | | | |
| | | (%) of | 50-800 μm | | | | |
| | | 50-800 μm | plane | Breaking | Percentage of dry | | |
| | Gelling | slurry oil | occupancy | stress | weight of ooze | Sensory evaluation | |
| | material | droplets | ratio (%) | (N/m²) | into filter paper | Oozing | Swallowing |
| Test | new | 0 | 0.3 | 12,500 | 5 | X | X |
| Example | Fujipro E | | | | | | |
| 1-1 | | | | | | | |
| Test | ↑ | 1.9 | 2.6 | 20,600 | 3 | X | X |
| Example | | | | | | | |
| 1-2 | | | | | | | |
| Test | ↑ | 39.6 | 21.9 | 11,150 | 12 | ◯ | ◯ |
| Example | | | | | | | |
| 1-3 | | | | | | | |
| Test | ↑ | 38.4 | 26.0 | 9,980 | 19 | ⊚ | ◯ |
| Example | | | | | | | |
| 1-4 | | | | | | | |
| Test | ↑ | 40.0 | 44.6 | 8,300 | 22 | ⊚ | ◯ |
| Example | | | | | | | |
| 1-5 | | | | | | | |

TABLE 7
Slurry oil droplet content (wt %) of oil-in-water-type emulsion slurry

| | | 0.01- | 0.1- | 1- | 10- | 30- | 50- | 80- | 120- | 200- | 300- | 500- | 800~ |
|---|---|---|---|---|---|---|---|---|---|---|---|---|---|
| | ~0.01 | 0.1 | 1 | 10 | 30 | 50 | 80 | 120 | 200 | 300 | 500 | 800 | (μm) |
| Test | 0 | 36.0 | 4.0 | 0 | 0 | 0 | 0 | 0 | 0 | 0 | 0 | 0 | 0 |
| Example | | | | | | | | | | | | | |
| 1-1 | | | | | | | | | | | | | |
| Test | 0 | 0 | 0 | 17.2 | 20.8 | 0.1 | 0.4 | 0.7 | 0.7 | 0.1 | 0 | 0 | 0 |
| Example | | | | | | | | | | | | | |
| 1-2 | | | | | | | | | | | | | |
| Test | 0 | 0 | 0 | 0 | 0 | 0.4 | 2.6 | 13.4 | 21.0 | 0.4 | 1.0 | 1.2 | 0 |
| Example | | | | | | | | | | | | | |
| 1-3 | | | | | | | | | | | | | |
| Test | 0 | 0 | 0 | 0.6 | 0.3 | 0.7 | 3.2 | 8.4 | 18.9 | 4.7 | 2.0 | 1.2 | 0 |
| Example | | | | | | | | | | | | | |
| 1-4 | | | | | | | | | | | | | |
| Test | 0 | 0 | 0 | 0 | 0 | 0 | 0 | 0.2 | 1.7 | 22.7 | 15.0 | 0.4 | 0 |
| Example | | | | | | | | | | | | | |
| 1-5 | | | | | | | | | | | | | |

TABLE 8
Diameter distribution of oil droplets in oil-in-water-type emulsion
gel (values in Table 8 are plane occupancy ratios (%))

| | 30-50 | 50-80 | 80-120 | 120-200 | 200-300 | 300-500 | 500-800 | 800~(μm) |
|---|---|---|---|---|---|---|---|---|
| Test | 0.4 | 0.3 | 0 | 0 | 0 | 0 | 0 | 0 |
| Example | | | | | | | | |
| 1-1 | | | | | | | | |
| Test | 1.4 | 1.9 | 0 | 0.7 | 0 | 0 | 0 | 0 |
| Example | | | | | | | | |
| 1-2 | | | | | | | | |
| Test | 6.0 | 8.5 | 7.7 | 4.5 | 1.2 | 0 | 0 | 0 |
| Example | | | | | | | | |
| 1-3 | | | | | | | | |
| Test | 3.7 | 9.1 | 7.8 | 9.1 | 0 | 0 | 0 | 0 |
| Example | | | | | | | | |
| 1-4 | | | | | | | | |
| Test | 0 | 2.4 | 2.2 | 11.5 | 9.1 | 9.2 | 10.2 | 0 |
| Example | | | | | | | | |
| 1-5 | | | | | | | | |

### Test Example 2

### Effects of Difference in Viscosity on Layer Separation

In the formation of oil-in-water-type emulsion slurries, not only the mixing ratio between a gelling material solution and oil and fat as ingredients but also the viscosity of the gelling material solution are important. As the viscosity decreases, an oil-in-water-type emulsion slurry is more easily obtained, but separation into an oil layer and a water layer is faster. In this test example, separation into an oil layer and a water layer was observed without adding the crosslinker solution, and the yield of an oil droplet layer was evaluated. Isolated soybean protein (frozen product B) was diluted, and 75 parts by weight of each of isolated soybean protein solutions having different viscosity (9,000-80 mPa·s) was prepared. 25 parts by weight of rapeseed oil (55° C.) was injected slowly while the solutions were being stirred with a propeller at 600 μm, and then each of the solutions was stirred at 600 rpm for 1 minute. Each of the solutions was then allowed to stand at 55° C. without adding the crosslinker solution. That time point was set to 0. For an oil layer (continuous layer of oil and fat) formed in the upper portion of the slurry, a water layer (continuous layer of protein solution) formed in the lower portion of the slurry, and an intermediate layer (oil droplet layer) therebetween, the volume % of each of the layers in the slurry (the volume % of each slurry in the whole slurry) was measured over time.

TABLE 9
Relationships between viscosity of gelling material solution and behavior of prepared slurry

| | | Viscosity (mPa · s) | | | | |
|---|---|---|---|---|---|---|
| Gelling | | 9,000 | 5,400 | 750 | 230 | 80 |
| material | | Protein concentration (wt %) | | | | |
| solution | | 12.6 | 11.2 | 9.8 | 8.4 | 7.0 |
| Evaluation of | after 0 min | water-in-oil | oil-in-water | oil-in-water | oil-in-water | oil-in-water |
| layer | | droplet | droplet | droplet | droplet | droplet |
| separation | after 2 min | 19/0/81 | 0/100/0 | 0/100/0 | 0/100/0 | 5/32/63 |
| Oil layer/ | after 8 min | 25/0/75 | 8/92/0 | 0/100/0 | 5/82/13 | 8/30/62 |
| oil droplet | after 16 min | 25/0/75 | 8/92/0 | 0/100/0 | 5/57/38 | 8/30/62 |
| layer/ | | | | | | |
| water layer | after 64 min | 25/0/75 | 8/92/0 | 3/77/20 | 5/33/62 | 8/23/69 |
| (volume %) | | | | | | |

| | | | | | |
|---|---|---|---|---|---|
| Comprehensive evaluation | impossible | good | good | possible | possible |

The viscosity of the gelling material solution influences the successful formation of oil-in-water droplets. When the viscosity was as high as 9,000 mPa·s, a water-in-oil-type emulsion was obtained, and an oil-in-water-type emulsion was not obtained. Meanwhile, when the viscosity was lower than 5,400 mPa·s, oil droplets were floated and combined to form an oil layer, but this formation was insignificant. Even in the case of an oil-in-water-type emulsion slurry having a viscosity of 80 mPa·s, the slurry was separated into water and oil over time. Particularly, in the case of a slurry having a low viscosity, the amount of water layer generated was more than 50%. This phenomenon can be overcome by selecting a suitable viscosity and performing treatment with the crosslinker solution. In addition, it is possible to obtain oil-in-water droplets by recovering and mixing again the separated protein solution and oil and fat.

### Test Example 3

### Effects of Difference in Oil Content on Texture of Oil-in-Water Emulsion-Type Gel Food

Now, the effects of a difference in the oil content of an oil-in-water-type emulsion gel food on the texture of the gel food will be illustrated in detail. A solution (protein concentration: 8.4 wt %) obtained by diluting isolated soybean protein (frozen product B) with water was elevated to 55° C., and 65, 50, 35, 20 and 5 parts by weight of rapeseed oil (55° C.) were injected slowly to 35, 50, 65, 80 and 95 parts by weight of the solution, respectively, while the solution was being stiffed with a propeller at 600 rpm. Next, the solutions were stirred with a propeller at 600 rpm for 1 minute, and 1 part by weight of the crosslinker solution described in Example 1 was added thereto. Then, each of the solutions was filled into a heat-resistant bag, heated at 55° C. for 30 minutes, and sterilized at 90° C. for 30 minutes. After heat has been removed with running water, the solutions in the bags were frozen overnight at −20° C., and each bag was thawed with running water before various analyses or testing, thereby obtaining samples. All the obtained samples, other than the sample having an oil content of 65% and comprising gel grains settled in the water-in-oil-type emulsion slurry, were all gels having a shape-retaining property. In a mastication test, the oozing of oil and fat from the sample having an oil content of 5% could not be felt

TABLE 10
Correlations between oil and fat concentration and gel food

| Composition and preparation method | | | | | |
|---|---|---|---|---|---|
| | | | Oil and | | |
| Gelling | Protein | Liquid | fat | | |
| material | concentration | viscosity | content | Sensory evaluation | |
| solution | (wt %) | (mPa · s) | (wt %) | Oozing | Swallowing |
| Soybean | 8.4 | 230 | 5 | X | Δ |
| (frozen | | | | | |
| product B) | | | | | |
| ↑ | ↑ | ↑ | 20 | Δ | ◯ |
| ↑ | ↑ | ↑ | 35 | ◯ | ◯ |
| ↑ | ↑ | ↑ | 50 | ⊚ | ⊚ |

| | | | | |
|---|---|---|---|---|
| ↑ | ↑ | ↑ | 65 | no shape-retaining |
| | | | | property |

### Test Example 4

### Effects of Thermal History of Soybean Protein on Texture

The relationships between thermal history and physical properties were examined. For solution A prepared in Preparation Example 1, various treatments were performed on a frozen product (frozen product A), a spray-dried product (powder product A, non-sterilized) and a sterilized and spray-dried product (powder product A). 60 parts by weight of a solution obtained by diluting each sample with any water was elevated to 55° C. and treated with 40 parts by weight of rapeseed oil (55° C.) in the same manner as described in Example 3. The obtained samples all had a shape-retaining property, and thus were provided for a mastication test. In the same concentration range (protein concentration: 10.6 wt %), the feeling of the oozing of oil and fat was better in the sample obtained using the soybean protein material containing a soybean protein having no thermal history of 80° C. or higher in a water system. Even in the case of the soybean protein material containing a soybean protein having a thermal history of 80° C. or higher in a water system, the feeling of the oozing of oil and fat from the sample was increased by reducing the soybean protein concentration from 10.6 wt % to 8.7 wt %. On the contrary, in the case of the soybean protein material containing a soybean protein having a thermal history of 80° C. or higher in a water system, the feeling of the oozing of oil and fat from the sample was reduced by increasing the protein concentration to 13.5 wt %.

TABLE 11
(Relationships among protein concentration, thermal history and gel
food)

| Composition and preparation method | | | | | |
|---|---|---|---|---|---|
| | Protein | Heating | Physical properties | | |
| Gelling | concentration | temperature | Breaking stress | Sensory evaluation | |
| material | (wt %) | (° C.) | (N/cm²) | Oozing | Swallowing |
| Soybean | 10.6 | 55 | 16,000 | ⊚ | ⊚ |
| (frozen | | | | | |
| product A) | | | | | |
| Soybean | ↑ | 76 | 14,000 | ⊚ | ⊚ |
| (powder | | | | | |
| product A, | | | | | |
| non- | | | | | |
| sterilized) | | | | | |
| Soybean | ↑ | 150 | 13,000 | ◯ | ◯ |
| (powder | | | | | |
| product A) | | | | | |
| Soybean | 8.7 | ↑ | 7,500 | ⊚ | ⊚ |
| (powder | | | | | |
| product A) | | | | | |
| Soybean | 13.5 | 55 | 50,400 | Δ | Δ |
| (frozen | | | | | |
| product A) | | | | | |

### Application Example 1

### Tuna Fat-Type Food

The gel food (Example 2) was cut in the form of a rectangle having a width of 7 mm, like sliced raw fish (sashimi), immersed in a seasoning solution (“Yamasa sashimi soy sauce (natural brewed; traditional preparing method in Japan)” manufactured by Yamasa Soy Source Co., Ltd.) for 30 seconds, dewatered by using colander, and dished up, thereby obtaining “a sashimi of fish and shellfish-type pickle food with soy sauce”. Oil that oozed from the food by mastication was mixed with soy sauce in mouth to exhibit a complex taste, and the food could be smoothly swallowed while a favorable taste and flavor were being felt. Even though the food had been heat-sterilized, it had a raw tuna fat-like texture. Even when a heat-sterilized gel food prepared using fish oil instead of rapeseed oil was prepared and used, the same effects as described above were obtained.

### Application Example 2

### Vegetable Fat-Containing Sushi

The gel food (Example 1) was cut into a size of 0.7×3×6 cm, and placed on rice seasoned with vinegar, thereby obtaining a tuna fat-type “vegetable fat-containing Sushi.” Meanwhile, the oil-in-water-type emulsion slurry stirred with a propeller was filled into a casing tube to prepare a thin and long gel food, and this thin and long gel food this was used as a food material, thereby obtaining a “vegetable fat-containing California roll.” The texture of the oozing of oil and fat was suitable for Sushi.

### Application Example 3

### Highly Nutritive Food

The frozen gel food (Example 1) was sliced to a thickness of 3 mm, cut to a size of 5 mm×10 mm, immersed for 3 minutes in a seasoning solution diluted two times with water, dewatered by using colander, and laid on a 7-minute-rice-gruel (prepared by adding a 7-fold amount of water to rice and cooking) put in a bowl, thereby obtaining a “soft, easy-to-eat highly nutritive meal.” Even when the meal was masticated with a tongue without using teeth or a gum, the oozing of oil and fat therefrom could be felt and the meal was smoothly swallowed.

### Application Example 4

### Raw Liver Sashimi-Type Food

The gel food (Example 3) was cut in the form of a rectangle having a width of 4 mm, immersed in a flavoring agent solution (a two-fold dilution of seasoning soup which contains “Honzou noodle (salt)” manufactured by Shimadaya Co., Ltd.), dewatered by using colander and placed on a dish, and chopped green onion was laid thereon, thereby obtaining a “raw liver sashimi-type food.” The food had a raw liver-like texture and a good flavor (the taste of salt-based soup and sesame), and thus was suitable as an accompaniment to a drink.

### Application Example 5

### Bacon Bits-Type Food

The “raw liver sashimi-type food” prepared using the gel food in Application Example 4 was stir-fried together with vegetables in a flying pan, thereby obtaining a “side dish having a warm and fresh texture.” When raw liver sashimi-type food was stir-fried without adding vegetables, oil and fat oozed therefrom, and thus the surface became crisp.

When it was heated again, “bacon bits-type snack” could be obtained.

### Application Example 6

### Vegetable Fat Topping

The gel food (Example 4) was cut to a size of 4 mm×2 mm×20 mm and topped on vegetables, thereby obtaining “vegetable fat-containing salad” that gives the flavor of olive virgin oil during mastication. Thus, the gel food (Example 4) was prepared using a 65-mm bent casing tube as a heat-resistant bag, and the obtained gel food was sliced to a size of 3 mm thickness×40 mm diameter, and rock salt was sprinkled thereon, thereby obtaining a “vegetable fat topping” that has a shape easily used for a sandwich, etc. The slices were topped on bread, sliced tomato and lettuce were laid thereon, and pepper was sprinkled thereon, thereby obtaining a “sandwich having a fresh feeling” that gives the flavor of olive during mastication.

### Application Example 7

### Vegetable Fat-Containing Seasoning

Although the gel food (Example 1) was sliced to a thickness of 3 mm and could be cooked in hot water using the Shabu-shabu way, it was swollen after 1 minute, and thus its texture was reduced. It had a pig fat-like texture topped on Ramen noodle. It tasted clean in that it had no fishy smell, but it tasted flat. Thus, according to the method of preparing a gel food (Example 1), a gel food was prepared using favored oil (Chinese chili oil (“Raiyu” manufactured by S&B Food Co., Ltd.) and garlic oil (manufactured by Pietro Inc.)) as substitute for half of rapeseed oil. The prepared gel food was cut into 3 mm blocks in a frozen state, bottled together with a flavoring agent solution (a seasoning soup), and heat-sterilized, thereby obtaining a “vegetable fat-containing seasoning” When it was topped on Ramen noodle, it increased the flavor of the Ramen noodle. In addition, it was suitable as a food material for fried rice or wonton or Chinese dumping.

### Application Example 8

### Tuna Middle Belly Meat-Type Food

The gel food (Example 9) was taken out of a home freezer (−5° C.), cut, and put. Meanwhile, when commercial tuna middle belly meat is stored at −20° C. for 2 weeks, it changes to a brown color and loses its original reddish color to reduce its value. Accordingly, housewives need to purchase belly meat from supermarkets or the like at current prices whenever middle belly meat is required, even though it is expensive. Meanwhile, the gel food of Example 9 or 1 maintains its reddish color even after 1-month storage in a home freezer (−5° C.), and thus it can be cut with a knife in a frozen state according to menu, suggesting that it is highly convenient.

### Application Example 9

### Fat Dessert Food

Maple syrup and cinnamon were sprinkled on the gel food (Example 7) to obtain a “fat dessert.” During initial mastication, the bending of the gel food was felt good. As mastication proceeded, gelatin in the gel food started to melt in the mouth, and white sesame oil that oozed onto the tongue mitigated the sweet taste of maple syrup and the flavor of cinnamon to give a changed flavor as gelatin is melted. Upon final swallowing, sugar, spice and the liquid oil were mixed with each other, and thus very smooth swallowing could be felt.

### INDUSTRIAL APPLICABILITY

The gel food of the present invention is a heat-sterilized food, but it can provide textures like those of unsterilized birds, beasts and fish and shellfish meat and be distributed in a frozen state. When the present invention is used, protein contained in soybeans, which attracts attention in terms of population issues and global environmental issues as well as economic efficiency and nutritive properties, can be combined with vegetable oil and fat, etc., which attracts attention, like soybeans. Accordingly, for people of all ages and genders in the countries of the world, the present invention can provide foods that have been heat-sterilized to kill bacteria and microorganisms, have textures like those of living birds, beasts and fish and shellfish meat (particularly a fish meat-like texture), and are obtained in the form of not only chilled foods and retort foods but also frozen foods resisting long-term shipment. Furthermore, the range of selection of foods is increased, leading to improvement in the quality of life (QOL). Specific examples include space foods, highly nutritive foods, emergency foods for disasters, foods for training of mastication and swallowing, meals for infants having low mastication ability or the aged having reduced mastication ability, etc. The present invention has the possibility of being used for general box lunches or side dishes, eating out, processed foods for home, solid seasonings containing oil, etc. Also, the present invention can contribute to healthy and abundant life through the creation of “foods.” In addition, the present invention can be applied to the fields or markets in which natural fat is used, thereby contributing to the protection of animal resources and a decrease in the load of livestock farming, etc.

1. An oil-in-water-type emulsion gel food that is obtained by gelling an oil-in-water-type emulsion slurry containing 10-60 wt % of oil droplets having a particle diameter of 50-800 μm.

2. The oil-in-water-type emulsion gel food of claim 1, wherein the oil droplets having the diameter of 50-800 μm have a plane occupancy ratio of 10-60%, and a gel formed by a non-myosin gelling material is present in a continuous phase.

3. An oil-in-water-type emulsion gel food that is obtained by gelling an oil-in-water-type emulsion slurry containing 30-50 wt % of oil droplets having a particle diameter of 50-800 μm.

4. The oil-in-water-type emulsion gel food of claim 3, wherein the oil droplets having the diameter of 50-800 μm have a plane occupancy ratio of 10-40%, and a gel formed by a non-myosin gelling material is present as a continuous phase.

5. The gel food of claim 4, wherein the gel food is a heat-sterilized food.

6. The gel food of claim 4, wherein the gel food is a frozen food.

7. The gel food of claim 4, wherein the gel is a soybean protein gel.

8. The gel food of claim 2, wherein the gel is a gel crosslinked by a protein crosslinking enzyme.

9. The gel food of claim 4, wherein:
A) the gel food has a breaking stress of 3,000-60,000 N/m2 as measured for a 20 mm thick sample using a spherical plunger (φ 5 mm) at 1 mm/second and at any one higher temperature of 20° C. and a melting point of oil and fat contained in the gel;
B) a percentage of dry weight of a squeezed liquid relative to the gel (a percentage of the squeezed liquid) is 10-60 wt %;
C) the gel formed by the non-myosin gelling material is present in a continuous phase; and
D) the oil and fat is present as an oil-in-water-type emulsion.

10. The gel food of claim 9, wherein the oil droplets having the diameter of 50-800 μm have a plane occupancy ratio of 10-60%.

11. The gel food of claim 9, wherein the gel food is a frozen food.

12. The gel food of claim 9, wherein the gel is a soybean protein gel.

13. The gel food of claim 9, wherein the gel is a gel crosslinked by a protein crosslinking enzyme.

14. A method for preparing a gel food of claim 13, wherein 25-150 parts by weight of oil and fat is added to 100 parts by weight of an aqueous solution having a soybean protein concentration of 5-15 wt % and having a viscosity of 5,500 mPa·s or less, as measured with a type B viscometer at 55° C. and at a rotator speed of 30 rpm, while the aqueous solution is being stirred, and is also treated with a protein crosslinking enzyme.

15. The method of claim 14, wherein soybean protein in a raw soybean protein material does not have a thermal history of 80° C. or higher in a water system.
